(19) United States
(12) Patent Application Publication
(10) Pub. No.: US 2006/0248355 A1
(43) Pub. Date: Nov. 2, 2006

(54) Power throttling system and method for a memory controller

(76) Inventor: Larry J. Thayer, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/115,675

(22) Filed: Apr. 27, 2005

(51) Int. Cl. G06F 1/00

(52) U.S. Cl. 713/300

(57) ABSTRACT

A power throttling method and system for a memory controller. In one embodiment, at least a first and a second throttle value are provided in the memory controller, the first and second throttle values for controlling memory operation cycles issued by the memory controller to one or more memory devices. Responsive to a throttle control signal, the memory controller selects a lower value of the first and second throttle values, whereby the memory operation cycles are issued to the memory devices at a reduced rate.

### BACKGROUND

One of the main reasons for the rapid change and growth in computer power requirements is the increase in volume of data processed, stored, transmitted, and displayed. As a result, power requirements have grown very rapidly over the last few years. To control the increase in power dissipation due to increased frequency and gate count, operating voltages have been reduced, since power scales as the square of voltage but scales linearly with respect to the frequency. Therefore, the increasing frequency demand forces the voltages down proportionally in order to maintain a reasonable level of power dissipation. Today, feeding this large amount of “ultraclean” current at low voltages with huge transient response capability has become the key technology driver of power management in computer systems.

Such power supply concerns assume particular significance in advanced memory designs currently being implemented. Additionally, rising bus and processing speeds are also demanding newer memory architectures that deliver improved performance by increasing clock frequencies and available bandwidth. However, as a result of these ever-increasing performance requirements, issues of power consumption and dissipation have become all the more critical in the field of computer system design.

It is well-known that a computer system's memory can contribute a significant portion of the total power. Since the system memory's consumption of power can be quite variable and unpredictable depending on transactional throughput, current designs are typically overprovisioned in terms of power supply, cooling, line power, and the like, so as to maximize the potential power dissipation. Such overprovisioning is not only inefficient in terms of cost, but operates as a significant design constraint on the system memory density.

### BRIEF DESCRIPTION OF THE DRAWINGS

FIG. 1 depicts a block diagram of an embodiment of an exemplary computer system wherein a power throttling scheme may be practiced in accordance with the teachings of the present disclosure;

FIG. 2 depicts a block diagram of a power distribution system for a memory module according to one embodiment;

FIG. 3 depicts a block diagram of an exemplary memory controller and memory bank assembly according to one embodiment;

FIG. 4 depicts a block diagram of an exemplary power throttling system according to one embodiment; and

FIG. 5 is a flowchart of an exemplary power throttling method according to one embodiment.

### DETAILED DESCRIPTION OF THE DRAWINGS

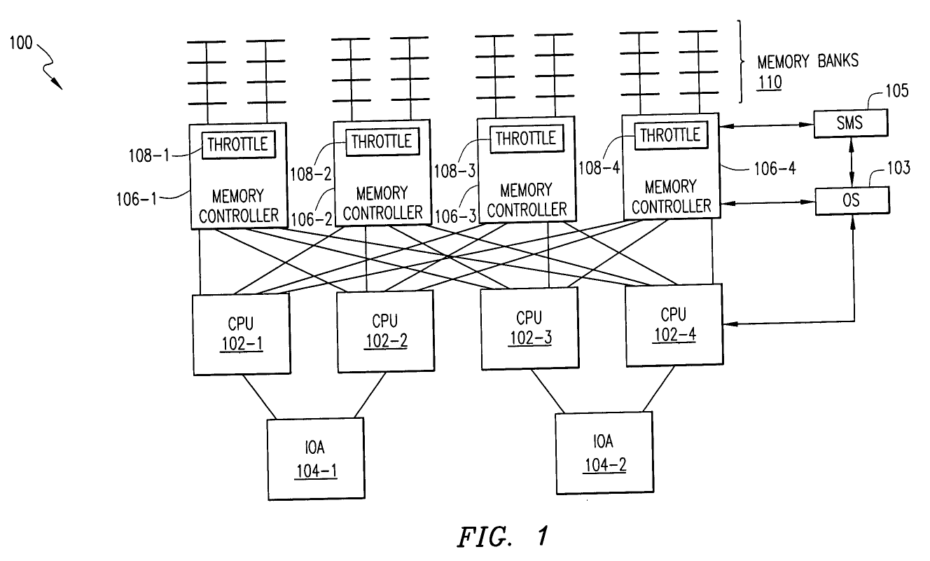

In the drawings, like or similar elements are designated with identical reference numerals throughout the several views thereof, and the various elements depicted are not necessarily drawn to scale. Referring now in particular to FIG. 1, depicted therein is a block diagram of an embodiment of an exemplary computer system 100 wherein a power throttling scheme for one or more memory controllers may be practiced in accordance with the teachings of the present disclosure. One or more processors, e.g., CPU 102-1 through CPU 102-4, are coupled to one or more input/output adapters (IOA) 104-1, 104-2 for carrying out input and output operations. Each of the processors is also coupled to memory controllers 106-1 through 106-4 which issue well-known memory operation cycles (such as, e.g., read cycles, write cycles, burst transaction cycles, etc.) to a number of memory banks 110. It should be realized that the memory banks 110 may be comprised of memory devices selected from at least one of dynamic random access memory (DRAM) devices, static random access memory (SRAM) devices, read-only memory (ROM) devices, and so on. For example, in one configuration, each of the memory banks 110 may be implemented as Dual In-line Memory Modules (DIMMS) having a plurality of a Double Data Rate (DDR) DRAM devices with a particular density, e.g., 256 Mb, 512 Mb, 1 Gb or 2 Gb, etc. Also, the memory devices can be of any known or heretofore unknown DDR type, e.g., DDR2 (operable with 1.8 V), DDR3 (operable with 1.35V to 1.5V), and the like. Further, the DIMM configuration of an exemplary memory module may include unbuffered DIMMs, registered DIMMs (RDIMMs), or fully buffered DIMMs (FBDs), and may be configured as having one or more ranks (e.g., 2, 4, 8, or more).

One or more instances of an operating system (OS) 103 are provided within the computer system 100 for controlling the operations therein. Those skilled in the art will recognize that OS 103 may comprise any UNIX-based operating system be such as, e.g., HP-UX®, AIX®, Linux®, Solaris®, etc., or other operating systems such as Microsoft® Windows®, Windows® XP®/NT®, as well as Macintosh® MacOS® operating system. Additionally, one or more system management software (SMS) applications 105 are provided as part of the software environment of the computer system 100.

Regardless of any particular memory architecture, density, technology, and configuration, the memory banks 110 are powered by one or more power modules (not explicitly shown in this FIGURE), either disposed within the associated memory controllers or provided separately. At any rate, the power output of the power modules varies depending on the functional and operational utilization of the memory banks 110. As will be described in detail hereinbelow, appropriate throttle control logic 108-1 through 108-4 is provided in association with the memory controllers 106-1 through 106-4 for throttling the power consumption of the memory banks 110.

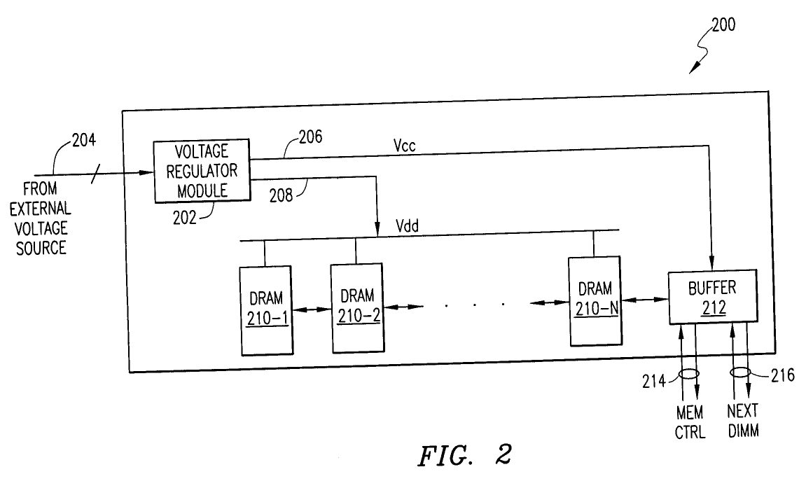

FIG. 2 depicts a block diagram of a power distribution system for a memory module 200 according to one embodiment. One or more memory devices 210-1 through 210-N are provided as part of the memory module 200, each receiving a first voltage path 208, typically referred to as a V_{dd} path, that may be energized to appropriate voltage levels depending on the type, functionality, and design of the memory devices, e.g., from about 0.5V to 3.5V or more. Where DIMMS are implemented, for instance, the DIMM configuration of the memory module 200 is exemplified as a fully buffered DIMM wherein a buffer/logic component 212 is provided for buffering command/address (C/A) space as well as data space at least for a portion of the memory devices 210-1 through 210-N. A bidirectional memory controller interface path 214 as well as a second voltage path 206, typically referred to as a V_{cc} path, are provided with respect to the buffer component 212, wherein the V_{cc} path may be energized to appropriate voltage levels depending on the buffer and DIMM technology, e.g., from about 0.5V to 3.5V or more. In addition, where multiple memory modules are daisy-chained on a single memory controller channel, a suitable daisy-chain interface 216 is provided for coupling the buffer component 212 to a next memory module.

In one embodiment, at least one on-board voltage regulator module (VRM) may be provided as part of the memory board assembly module 200 for converting an externally supplied voltage level available on external source path 204 from a power module into appropriate local voltage levels that power the first and second voltage paths, i.e., the V_{dd} and V_{cc} paths 208, 206, respectively. Preferably, a high-frequency switching voltage converter capable of generating tightly-controlled voltage levels may be implemented as the on-board VRM 202. For instance, multi-phase synchronous Pulse-Width Modulated (PWM) controllers, Low Drop-Out (LDO) controllers, et cetera, that are capable of accepting unregulated supply voltages over a broad range may be configured to operate as a local voltage supply for the memory module 200.

Those skilled in the art should recognize upon reference hereto that although providing a tightly-controlled VRM as local voltage supply for on-board power requirements may give rise to a number of advantages in the power supply design of an electronic component such as the memory module 200, some designs may not incorporate any on-board VRMs. It should be apparent, however, that irrespective of how the power supply is designed, the memory module 200 can exhibit highly variable power consumption levels depending on the memory operation activity.

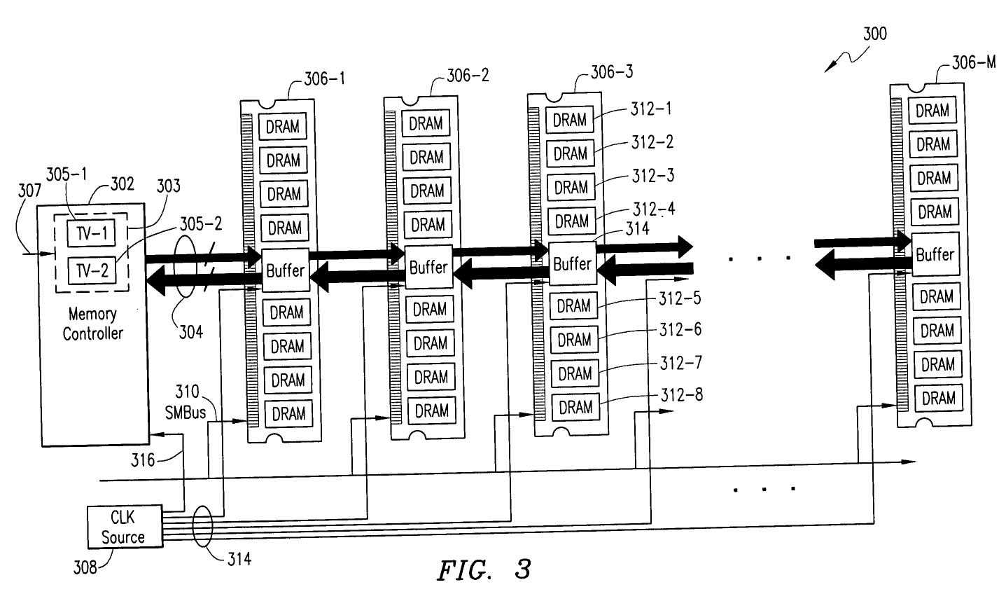

FIG. 3 depicts a block diagram of an exemplary memory controller and memory bank assembly 300 according to one embodiment. A memory controller 302, which is illustrative of the memory controllers 106-1 through 106-4 shown in FIG. 1, is operable to drive a bidirectional memory link 304 to which a plurality of memory boards 306-1 through 306-M are coupled in a daisy-chain fashion at their respective buffers. As exemplified by the memory board 306-3, each memory board includes eight DRAM devices 312-1 through 312-8, with a buffer component 314. A clock source 308 is operable to drive a plurality of clock signals to the memory boards via a clock bus 314. Additionally, the clock source 308 is also operable to drive a clock signal 316 to the memory controller 302 for providing a time base with respect to its memory operation cycles. A system management bus (SM bus) 310 is coupled to the memory boards 306-1 through 306-M. Although not explicitly shown in this FIGURE, each memory board also receives a power supply path for powering the DRAM and buffer components therein. In one arrangement, the supply voltage may be sourced from the memory controller 302 or from a separate voltage source.

A throttle control logic block 303 associated with the memory controller 302 includes a plurality of storage elements for storing a set of appropriate throttle values (TVs) thereat. By way of illustration, the storage elements may be comprised of registers 305-1, 305-2 for storing at least a first and second throttle values, respectively. The throttle control logic block 303 is operable responsive to a throttle control signal 307 for selecting a particular throttle value that determines whether memory operation cycles are issued by the memory controller 302 to the memory boards 306-1 through 306-M at a reduced rate or an increased rate.

One skilled in the art should appreciate that by providing more than two throttle values, a range of power throttling behavior can be implemented for a particular memory controller without affecting its clock source. In one implementation, a lower TV setting corresponds to issuing fewer memory operation cycles and a higher TV setting corresponds to issuing more frequent memory operation cycles. Where two TVs are provided, e.g., TV-1 and TV-2 associated with the memory controller 302, the throttle control signal 307 may be placed in one of two states that can select between the two TV settings. On the other hand, more complex selection logic may be implemented for selecting among a range of TV settings based on one or more throttle control signals and associated logic states.

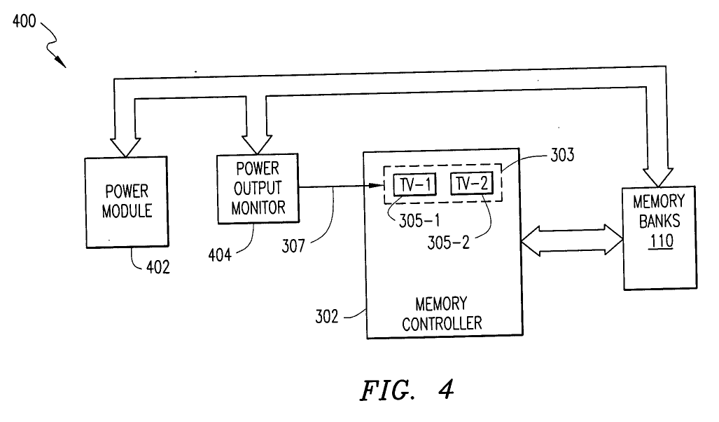

FIG. 4 depicts a block diagram of an exemplary power throttling system 400 according to one embodiment which may be implemented in multiprocessor environments (such as, e.g., the computer system 100 shown in FIG. 1) as well as single-processor environments. A power module 402 is operable to supply power to one or more memory banks 110 controlled by the memory controller 302. A power output monitor 404 associated with the power module 402 for monitoring output power is operable to drive the throttle control signal 307 to the memory controller 302. If the monitor 404 detects a power level that is greater than a predetermined value, the throttle control signal 307 is driven to an over-current state which, in turn, indicates to the TV selection logic of the memory controller 302 that a lower TV is to be selected, whereby a reduced rate of memory operation cycles are issued to the memory bank 110. Accordingly, the memory bank 110 uses less power when throttled with fewer cycles. When the power has returned to a level that is within an acceptable range, the power output monitor 404 drives the throttle control signal 307 to its original state, i.e., normal current state, thereby permitting the memory controller 302 to throttle using a higher TV setting which results in issuing cycles more frequently. As a consequence, both power and performance of the memory bank 110 are increased.

It should be appreciated upon reference hereto that although the block diagram of the exemplary power throttling system 400 is shown with discrete blocks, some of the components may be integrated within a single assembly. For instance, the functionality of the power output monitor 404 may be integrated within the power module 402, which in turn may be provided as part of a controller board that includes the memory controller 302. By way of implementation, a differential operational amplifier (opamp) or a resistor-based current sensor can be used for monitoring the output power. Additionally, the TV settings of the memory controller 302 may be provided to be programmable to any desired power level. In one embodiment, the contents of the TV storage elements are operable to be configured by an OS running on the computer system. In another embodiment, the contents of the TV storage elements are operable to be configured by a system management software application. In a still further embodiment, the contents of the TV storage elements are operable to be dynamically configured by a user. If, for example, the total system power is too high over a period of time, the TVs may be set to a constant low value. Upon returning to a more normal power level, the TVs may be set to different values for throttling at variable levels.

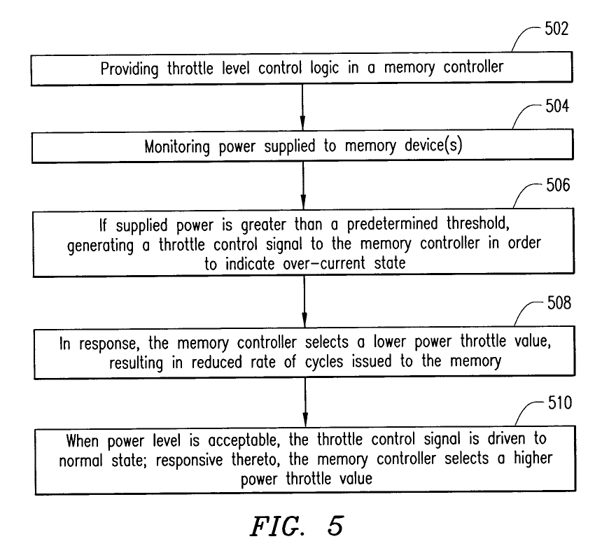

FIG. 5 is a flowchart of an exemplary power throttling method according to one embodiment. At block 502, appropriate throttle level control logic is provided in a memory controller. As described hereinabove, at least a first and second throttle values may be provided for controlling memory operation cycles issued by the memory controller at two levels to one or more memory devices. Power supplied to the memory devices is monitored by way of a suitable power output monitor (block 504). If supplied output power is greater than a predetermined threshold value, a throttle control signal is generated to the memory controller in order to indicate an over-current state (block 506). In response, the memory controller selects a lower throttle value, whereby memory operation cycles are issued to the memory at a reduced rate (block 508). When the output power level is within an acceptable range, the throttle control signal is driven to a normal current state. Responsive thereto, the memory controller selects a higher power throttle value, whereby memory operation cycles are issued to the memory devices at an increased rate (block 510).

Based on the foregoing Detailed Description, it should be appreciated that an implementation of the embodiments described herein thus provides a technology-independent power throttling scheme for memory controllers disposed in any known or heretofore unknown computer environments. The embodiments are intended to be flexible enough to respond quickly to a surge in power so that power supply modules do not have to be over-designed. Additionally, the embodiments are sufficiently adaptable in that fairly precise power limits can be selected over a broad range of power supply spectrum. By throttling memory power consumption in real-time, a computer system can be designed to dissipate a significant amount of power in a dynamic manner, so that drastic overprovisioning in terms of power supply, cooling systems, line power design, etc., can be avoided advantageously.

Although the invention has been described with reference to certain exemplary embodiments, it is to be understood that the forms of the invention shown and described are to be treated as illustrative only. Accordingly, various changes, substitutions and modifications can be realized without departing from the scope of the present invention as set forth in the following claims.

What is claimed is:

1. A power throttling method for a memory controller, comprising:
providing at least a first and second throttle value in said memory controller, said at least first and second throttle values for controlling memory operation cycles issued by said memory controller to one or more memory devices; and
responsive to a throttle control signal, selecting by said memory controller a lower value of said at least first and second throttle values, whereby said memory operation cycles are issued to said one or more memory devices at a reduced rate.

2. The power throttling method for a memory controller as recited in claim 1, wherein said at least first and second throttle values are configured by an operating system (OS).

3. The power throttling method for a memory controller as recited in claim 1, wherein said at least first and second throttle values are configured by a system management software application.

4. The power throttling method for a memory controller as recited in claim 1, wherein said at least first and second throttle values are dynamically configured by a user.

5. The power throttling method for a memory controller as recited in claim 1, wherein said one or more memory devices comprise at least one of dynamic random access memory (DRAM) devices, static random access memory (SRAM) devices, and read-only memory (ROM) devices.

6. The power throttling method for a memory controller as recited in claim 1, further comprising:
monitoring output power from a power module operating to power said one or more memory devices; and
if said output power is greater than a predetermined value, generating said throttle control signal to said memory controller.

7. The power throttling method for a memory controller as recited in claim 6, further comprising:
upon determining that said output power is within an acceptable range, driving said throttle control signal to a level indicative of a normal current state; and
responsive to said normal current state indicated by said throttle control signal, selecting by said memory controller a higher value of said at least first and second throttle values, whereby said memory operation cycles are issued to said one or more memory devices at an increased rate.

8. The power throttling method for a memory controller as recited in claim 6, wherein said output power is monitored by a current sensor.

9. The power throttling method for a memory controller as recited in claim 6, wherein said output power is monitored by an operational amplifier (opamp).

10. The power throttling method for a memory controller as recited in claim 6, wherein said output power is monitored for identifying an over-current state.

11. A power throttling system for a memory controller, comprising:
throttle logic for storing at least a first and second throttle value in said memory controller, said at least first and second throttle values for controlling memory operation cycles issued by said memory controller to one or more memory devices; and
means, operable responsive to a throttle control signal, for selecting by said memory controller a lower value of said at least first and second throttle values, whereby said memory operation cycles are issued to said one or more memory devices at a reduced rate.

12. The power throttling system for a memory controller as recited in claim 11, wherein said at least first and second throttle values are configured by an operating system (OS).

13. The power throttling system for a memory controller as recited in claim 11, wherein said at least first and second throttle values are configured by a system management software application.

14. The power throttling system for a memory controller as recited in claim 11, wherein said at least first and second throttle values are dynamically configured by a user.

15. The power throttling system for a memory controller as recited in claim 11, wherein said one or more memory devices comprise at least one of dynamic random access memory (DRAM) devices, static random access memory (SRAM) devices, and read-only memory (ROM) devices.

16. The power throttling system for a memory controller as recited in claim 11, further comprising:
means for monitoring output power from a power module operating to power said one or more memory devices; and
means for driving said throttle control signal to said memory controller if said output power is greater than a predetermined value.

17. The power throttling system for a memory controller as recited in claim 16, wherein said output power is monitored for identifying an over-current state.

18. The power throttling system for a memory controller as recited in claim 16, further comprising:
means for driving said throttle control signal to a level indicative of a normal current state upon determining that said output power is within an acceptable range; and
means, operable responsive to said normal current state indicated by said throttle control signal, for selecting by said memory controller a higher value of said at least first and second throttle values, whereby said memory operation cycles are issued to said one or more memory devices at an increased rate.

19. The power throttling system for a memory controller as recited in claim 16, wherein said means for monitoring said output power comprises a current sensor.

20. The power throttling system for a memory controller as recited in claim 16, wherein said means for monitoring said output power comprises an operational amplifier (opamp).

21. A computer system, comprising:
at least one processor coupled to a memory controller that is operable to issue memory operation cycles to one or more memory devices; and
throttle control logic associated with said memory controller for selecting a throttle value operable to control memory operation cycles issued by said memory controller, said throttle control logic operating responsive to a throttle control signal generated by a power output monitor that monitors output power from a power module supplying power to said one or more memory devices.

22. The computer system as recited in claim 21, wherein said throttle control logic comprises a set of registers for storing at least a first and second throttle value that are configurable by an operating system (OS) executing on said computer system.

23. The computer system as recited in claim 21, wherein said throttle control logic comprises a set of registers for storing at least a first and second throttle value that are configurable by a system management software application executing on said computer system.

24. The computer system as recited in claim 21, wherein said throttle control logic comprises a set of registers for storing at least a first and second throttle value that are dynamically configurable by a user.

25. The computer system as recited in claim 21, wherein said power output monitor is operable to drive said throttle control signal to an over-current state if said output power is greater than a predetermined value.

26. The computer system as recited in claim 25, wherein said throttle control logic is operable to select a lower throttle value responsive to said throttle control signal being driven to said over-current state, whereby said memory operation cycles are issued to said one or more memory devices at a reduced rate.

27. The computer system as recited in claim 21, wherein said power output monitor is operable to drive said throttle control signal to a normal current state if said output power is within a predetermined range.

28. The computer system as recited in claim 27, wherein said throttle control logic is operable to select a higher throttle value responsive to said throttle control signal being driven to said normal current state, whereby said memory operation cycles are issued to said one or more memory devices at an increased rate.

29. The computer system as recited in claim 21, wherein said one or more memory devices comprise at least one of dynamic random access memory (DRAM) devices, static random access memory (SRAM) devices, and read-only memory (ROM) devices.

30. A power throttling apparatus for a memory controller disposed in a computer system, comprising:
a set of registers for storing at least a first and second throttle value, said at least first and second throttle values for controlling memory operation cycles issued by said memory controller to one or more memory devices; and
a power output monitor for monitoring output power from a power module operating to power said one or more memory devices, wherein said power output monitor generates a throttle control signal to said memory controller for selecting between said first and second throttle values based on said output power.

31. The power throttling apparatus for a memory controller disposed in a computer system as recited in claim 30, wherein said at least first and second throttle values are configured by an operating system (OS) executing on said computer system.

32. The power throttling apparatus for a memory controller disposed in a computer system as recited in claim 30, wherein said at least first and second throttle values are configured by a system management software application executing on said computer system.

33. The power throttling apparatus for a memory controller disposed in a computer system as recited in claim 30, wherein said at least first and second throttle values are dynamically configured by a user.

34. The power throttling apparatus for a memory controller disposed in a computer system as recited in claim 30, wherein said power output monitor is operable to drive said throttle control signal to an over-current state if said output power is greater than a predetermined value.

35. The power throttling apparatus for a memory controller disposed in a computer system as recited in claim 34, wherein said memory controller is operable to select a lower value of said first and second throttle values responsive to said throttle control signal being driven to said over-current state, whereby said memory operation cycles are issued to said one or more memory devices at a reduced rate.

36. The power throttling apparatus for a memory controller disposed in a computer system as recited in claim 30, wherein said power output monitor is operable to drive said throttle control signal to a normal current state if said output power is within a predetermined range.

37. The power throttling apparatus for a memory controller disposed in a computer system as recited in claim 36, wherein said memory controller is operable to select a higher value of said first and second throttle values responsive to said throttle control signal being driven to said normal current state, whereby said memory operation cycles are issued to said one or more memory devices at an increased rate.

38. The power throttling apparatus for a memory controller disposed in a computer system as recited in claim 30, wherein said one or more memory devices comprise at least one of dynamic random access memory (DRAM) devices, static random access memory (SRAM) devices, and read-only memory (ROM) devices.

39. The power throttling apparatus for a memory controller disposed in a computer system as recited in claim 30, wherein said power output monitor comprises a current sensor.

40. The power throttling apparatus for a memory controller disposed in a computer system as recited in claim 30, wherein said power output monitor comprises an operational amplifier (opamp).
